(19) United States
(12) Patent Application Publication
(10) Pub. No.: US 2008/0129035 A1
(43) Pub. Date: Jun. 5, 2008

(54) Method of personalizing or customizing a container or dispenser

(76) Inventors: Duane Lyle McDonald, Neenah, WI (US); Raymond Paul Pitsch, Appleton, WI (US); Shiva Nicole Scotti, Pataskala, OH (US); Cynthia Watts Henderson, Neenah, WI (US); Allen Jerry Marquardt, Appleton, WI (US); Andrew Peter Bakken, Appleton, WI (US); Thomas Gerard Shannon, Neenah, WI (US); Timothy Patrick Clare, Kernersville, NC (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/607,294

(22) Filed: Dec. 1, 2006

(51) Int. Cl. B42D 15/00

(52) U.S. Cl. 283/67

(57) ABSTRACT

The present invention provides a process of personalizing or customizing a container or dispenser for a customer or shopper. More specifically, the present invention relates to a process of mass personalization or customization of containers or dispensers containing useable products.

### FIELD OF THE INVENTION

The present invention relates to a process of customizing a container or dispenser. More specifically, the present invention relates to a process of mass personalization or mass customization of containers or dispensers.

### BACKGROUND OF THE INVENTION

The outer surfaces of containers or dispensers of products, in particular consumer products, are often provided with graphics, decorative designs, informative information or a combination thereof. One example of such containers and dispensers are those containers which are used for dispensing facial tissue. Facial tissue dispensers are often preprinted with graphics, decorative designs and/or informative information for consumers, users and non-users to view. Since these dispensers are generally placed throughout the home, consumers often desire that the dispensers have an aesthetically pleasing design which will blend in with the décor of the consumer's home or place of use. Facial tissue containers or dispensers are generally in the form of a carton, which is typically made from paperboard. These cartons are generally flat upon arrival to the manufacturer or packager of the tissue, formed into a container or dispenser by the tissue manufacturer or packager, and loaded with the facial tissue and then sealed by the facial tissue manufacturer or packager. Typically, the cartons arrive at the site of manufacture of the facial tissue or the site of packaging of the facial tissue with the graphics, decorative designs and/or information being already preprinted on the paperboard cartons. While these cartons are very functional in dispensing facial tissue, these cartons are often aesthetically limited and may be aesthetically unappealing to some consumers. As a result, it is often necessary for the manufacturer or packager of these dispensing cartons to produce several different graphic designs to ensure acceptance by a wide variety of consumers. Even with the several different designs being available, consumers as well as retailers are provided with a limited number of designs.

Another method of providing containers or dispensers of consumer products with graphics or informative information is to provide and apply a label to the outer surface of the container or dispenser. Currently, labels which are paper-based or polymeric film-based are being used. While labels may provide the manufacturer or packager of consumer products with an easy way to provide information on a container or dispenser of consumer products, often labels are found to be unattractive by consumers since, in most cases, the label only covers a portion of the outer surface of the container or dispenser or only provide information. As a result, labels are often found to be unattractive to consumers, unless the labels are applied to a container or dispenser with additional graphics or decorative designs being applied to the container or dispenser.

In addition, during particular holidays and seasons of a given calendar year, it may be advantageous for the manufacturer or packager of consumer products to provide products which are seasonal or are related to the particular holiday time of the year. For example, during the spring, it may be desirable to provide to consumers spring related graphics or decorative designs on the containers or dispensers of consumer products, such as flowers. Likewise, during the Christmas season, providing Christmas ornaments or other Christmas related scenes may be advantageous to the manufacturer or packager of the consumer products.

In the prior methods of producing containers or dispensers for consumer products, there is not a way provided which will allow the manufacturer or packager of the consumer products to change the graphics or decorative designs on short notice to meet demands for particular graphics or decorative designs. In the prior methods, the manufacturer typically orders or produces the cartons or dispensers with the graphics or designs prior to loading the consumer product into the container or dispenser. Often, the containers or dispensers with the least attractive graphics or decorative designs are left on retail shelves for an extended period of time. As a result, there is a need in the art for a process to provide a container or dispenser of consumer products, which allows the manufacturer or packager a convenient and fast way to provide a wide variety of graphics to retailers and consumers, to meet demands of the consumers. In addition, there is a need in the art to allow a retailer or a consumer to select graphics or decorative designs on containers of consumer products, such as facial tissue, that will meet the desires or needs of the consumer and/or retailer on an ongoing basis.

### SUMMARY OF THE INVENTION

Generally stated, in one embodiment of the present invention, provided is a method for customizing graphics, images or decorative designs on a container or dispenser. In this method, a blank container or dispenser is provided. Before, after or at the same time the blank container or dispenser is provided, a shopper or customer is provided with the ability to select or provide a graphic, image or decorative design to be placed on the blank container or dispenser. Once the customer or shopper selects a graphic, image or decorative design desired to be placed on the blank container or dispenser, the graphic, image or decorative design selected by the shopper or customer is prepared. In the first embodiment of the present invention, the graphic, image or decorative design is prepared on a web of a material. Typically, the graphic, image or decorative design is printed onto the web of material. After the graphic, image or decorative design is prepared on the web of material, the web of material having the graphic, image or decorative design selected by the shopper or customer thereon is positioned next to the blank container or dispenser. Generally, the graphic, image or decorative design faces away from an outside surface of the container or dispenser; however, if the web of material is translucent or transparent, it is possible for the image on the web of material to be placed against the container or dispenser. The web of material with the graphic, image or decorative design selected by the shopper or customer is held adjacent to the container or dispenser with a shrinkable polymeric film, thereby forming a customized container or dispenser having a graphic, image or decorative design selected by a customer or shopper.

In another embodiment of the present invention, a method for customizing graphics on a container or dispenser is provided. In this embodiment of the present invention, a blank container or dispenser comprises a top surface, a bottom surface opposite the top surface and at least one side surface joining the top surface to the bottom surface, the at least one side surface having a total surface area equal to the area of all of the side surfaces present on the blank container or dispenser. Before, after or at the same time the container or dispenser is provided, a customer or shopper is provided with the ability to select or provide a graphic, image or decorative design desired to be placed on the blank container or dispenser. The shopper or customer selects at least one graphic or at least one image desired by the shopper or customer to be placed on the blank container or dispenser. Once selected, the graphic, image or decorative design is applied onto a web of material. The web of material with the graphic, image or decorative design thereon is applied onto at least one side surface of the blank container or dispenser such that at least 50% of the total area of the at least one side is covered by the graphic, image or decorative design.

In another embodiment of the present invention, provided is a method for customizing graphics on a container or dispenser. In this embodiment of the present invention, a blank container or dispenser containing a personal care product is provided. Before, after or at the same time the container or dispenser is provided, an interface via a communication network is provided for a shopper or customer to select or to provide graphics, images or decorative designs from a server or upload graphics, images or decorative designs to a server connected to the communications network. Next, the shopper or customer uploads to the server at least one graphic or at least one image desired by the shopper or customer to be placed on the blank container or dispenser. Alternatively, the shopper or customer selects a graphic, image or decorative design provided to them on the server to be placed onto the container or dispenser. After the graphic, image or decorative design is uploaded or selected, the graphic, image or decorative design desired by the shopper or consumer is applied onto a web of material. Various methods may be used to place the graphic, image or decorative design onto the web of material, including, for example, printing. Once the graphic, image or decorative design is placed onto the web of material, the web of material with the graphic, image or decorative design thereon is placed onto the blank container or dispenser to form a customized container or dispenser. Next, the customized container or dispenser is provided to the shopper or customer.

A further embodiment of the present invention is directed to another method of preparing and providing a container or dispenser with a customized graphic, image or decorative design. In this embodiment of the present invention, a plurality of blank containers or dispensers containing a product is provided to a third party. Before, during or after the containers or dispensers are provided to the third party, a means for a shopper or customer to customize the container or dispenser with graphics, images or decorative designs desired by the shopper or customer, is provided to shoppers or customers. Before or after the customization occurs, a means is provided to the shopper or customer to order a single or a plurality of customized containers or dispensers. Once the shopper or customer orders the customized container or dispenser, the third party applies the customized graphics, images or decorative designs to the blank container or dispenser to form a customized container or dispenser. As with the previous embodiments of the present invention, the graphic, image or decorative design desired by the shopper or customer is applied to a web of material and the web of material is applied to an outer surface of the container or dispenser. After the third party prepares the customized container or dispenser containing the product, the third party supplies the customized container or dispenser containing the product to the shopper or customer.

In each embodiment of the present invention described above, the container or dispenser may contain a useable product. Examples of usable product include, for example, personal care products. One particular product that may be present in the container or dispenser is a plurality of facial tissues.

Also in each embodiment of the present invention, the shopper or customer may select or provide the graphic, image or decorative design via a communications network. The communications network may include communications networks such as the internet. Typically, the user will select the graphic, image or decorative design from a library of graphics, images or decorative designs through a computer interface, such as a personal computer or other similar device. The computer interface may be located in the shopper's or customer's place of business, home or located at a retail location, such as a retail store. The interface is connected to the communications network, such as a server, where the information inputted by the shopper or customer is stored.

The dispensers or containers, in each of the embodiments of the present invention, typically will have a top surface, a bottom surface and a side surface, wherein the side surface connects the top surface to the bottom surface. There may be a single continuous side surface or there may be more than one distinct face which make-up the side surface of the container. In one aspect of the present invention, the side surface is a sidewall having a curvilinear shape, such as an oval.

### BRIEF DESCRIPTION OF THE DRAWINGS

FIG. 1 shows a flow diagram for a process of one embodiment of the present invention.

FIG. 2 shows a flow diagram for a process of another embodiment of the present invention.

FIG. 3 shows a block diagram of a communications network useable in the present invention for a customer or shopper to customize and order a dispenser or container of the present invention.

FIG. 4 shows a cut-away top perspective view of a blank container or dispenser usable in the present invention.

FIG. 5 shows a cut-away top perspective view of a customized container or dispenser of the present invention.

FIG. 6A and FIG. 6B show sectional views of the construction of the bottom and sidewall connection of a container or dispenser component usable in the present invention.

FIG. 7 shows a sectional view of the construction of the top and sidewall of a container or dispenser component usable in the present invention.

FIG. 8 shows an embodiment of the present invention where the graphics or decorative designs are imprinted on the interior surface of a shrinkable film.

FIG. 9 shows an embodiment of the present invention where a first layer contains the graphics or decorative designs and the first layer is covered with a heat-shrinkable film.

FIGS. 10A-10D show a method of placing the web of material with the graphic, image or decorative design and/or the shrinkable film around the container or dispenser.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the terminology such as “vertical”, “horizontal”, “top”, “bottom”, “front”, “back”, “end” and “sides” are referenced according to the views presented. It should be understood, however, that the terms are used only for purposes of description, and are not intended to be used as limitations. Accordingly, orientation of an object or a combination of objects may change without departing from the scope of the invention. As a point of reference for the claims and in the present specification, the term “top” refers to a panel or side of the package with an opening device or opening.

As used herein, the term “opening” refers to a portion of the top surface which allows a user to access the product housed within the interior volume of the container or dispenser.

As used herein, the term “shopper” refers to a person who purchases a product from a manufacturer, retailer, or wholesaler with the intention of using the product for their own personal use or purchase the product for another individual to use. The term shopper is also synonymous with the term “consumer”.

As used herein, the term “customer” means an individual or entity that purchases a product from a manufacturer or wholesaler with the intention of reselling the product to a shopper. For example, a retailer who purchases product for resale from a manufacturer is a customer of the manufacturer.

As used herein, the term “consumer products” is intended to mean products which include durable and non-durable goods which are purchased by or for a user of the products. Consumer products are intended to include, by way of example only, health and hygiene items, including absorbent personal care articles, facial and bath tissue, and dry and wet wipes and the like. The product may be cellulosic based products, meaning that the products contain cellulose fibers.

The term “disposable” is used herein to describe products that are not intended to be laundered or otherwise restored or reused as an absorbent article after a single use.

As used herein, the term “external side surface” refers to an outer side surface of the container or dispenser which typically faces away from the products which are contained within the container or dispenser. The surface may be a sidewall, a top or bottom of the container or dispenser. Depending on the shape of the container or dispenser, the number of surfaces may be different for each shape. For example, a generally cylindrical or oval carton would have three external surfaces, a continuous side surface, the top surface and the bottom surface. A parallelepiped box would have six external side surfaces, including the top surface, the bottom surface and four sidewall surfaces.

As used herein, the term “blank” in the context of blank containers or blank dispensers is intended to mean a container or dispenser with a portion of at least one surface is not provided with a graphic, image or decorative design, so that a graphic, image or decorative design may be applied to the container or dispenser. A blank may be completely devoid of graphics or have only a portion of the container or dispenser devoid of graphic, images or decorative design.

As used herein, the term “container” is intended to mean an article which is capable of holding a product. Also as used herein, the term “dispenser” is intended to mean a container which will also dispense the product from the container.

As used herein, the phrase “graphic, image or decorative design” is intended to cover a wide variety of items which may be placed on the article of manufacture. The term “graphic” is intended to mean features which are generally repeated in a pattern or other features such as a monogram. For example, a repeated pattern of an object is intended to be a graphic. The term “image” generally means a picture, such as a photograph or a painting, but could include other picture-like items such as a silhouette or other similar feature. The term “decorative design” is intended to mean a design which is neither a graphic nor an image per se; however, a decorative design could be the combination of a graphic or pattern.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and random symmetries.

### DETAILED DESCRIPTION OF THE INVENTION

In the following detailed description of the present invention, reference is made to the accompanying drawings which form a part hereof, and in which is shown by way of illustration, specific embodiments in which the inventions may be practiced. These embodiments are described in sufficient detail to enable those skilled in the art to practice the invention, and it is to be understood that other embodiments may be utilized and that mechanical, procedural, and other changes may be made without departing from the spirit and scope of the present invention. The following detailed description is, therefore, not to be taken in a limiting sense, and the scope of the present invention is defined only by the appended claims, along with the full scope of equivalents to which such claims are entitled.

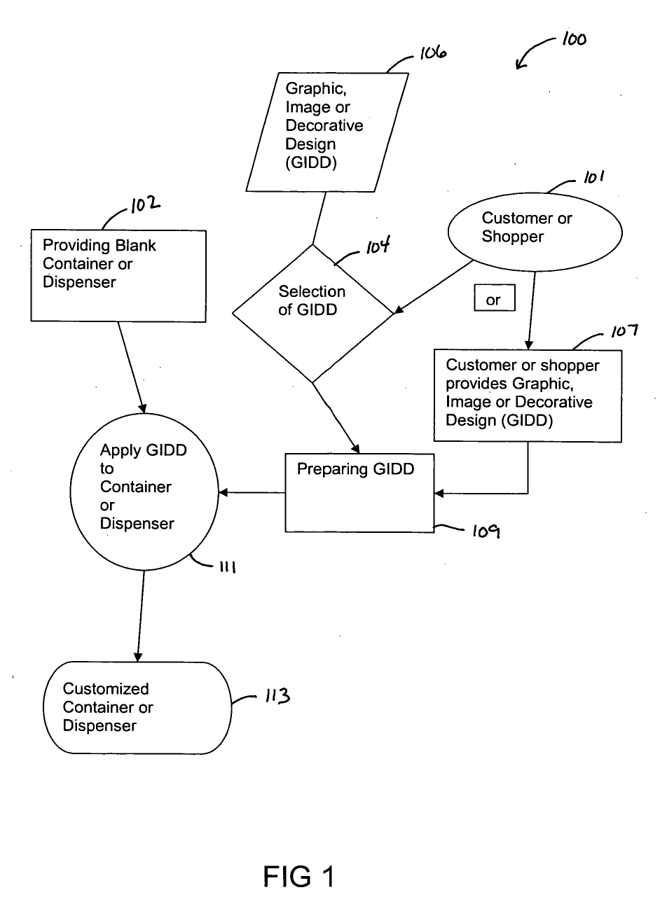

The present invention provides a method for customizing graphics, images or decorative designs on a container or dispenser. To gain a better understanding of the present invention, attention is directed to FIG. 1, which shows a flow diagram 100 of embodiments of the present invention. The process of the present invention, in each of the embodiments of the present invention, starts with a blank container or dispenser, which is indicated in block 102. Generally stated, the blank container or dispenser of the present invention may be formed in many different shapes and sizes without departing from the scope of the present invention. In a described embodiment of the present invention, the container or dispenser has a generally circular or oval shape. Other shapes may be used for the container of the present invention without departing from the scope of the present invention, including, for example, a parallelepiped container or dispenser, a cubical container or dispenser or other shape which is capable of holding and dispensing products from the container or dispenser component. A more detailed description of the blank container or dispenser and the customized container or dispenser prepared by the process of the present invention is provided below.

Before, after or at the same time the blank container or dispenser is being prepared or provided, the process of the present invention provides a shopper or customer, block 101, with the ability to select a graphic, image or decorative design, block 104, to be placed on the blank container or dispenser. In order to continue in the process of the present invention, the shopper or customer must select a graphic, image or decorative design to be placed on the container or dispenser. The graphic, image or decorative design may be provided to the shopper or customer, block 106, or, in the alternative or in addition, the shopper or customer may provide the graphic, image or decorative design, block 107, desired to be placed on the container or dispenser.

When the graphics, images or decorative designs are provided to the shopper or customer for selection, the graphics, images or decorative designs are provided as a library or set of graphics, images or decorative designs. The graphic, image or decorative design within the library or set of graphics, images or decorative designs may be provided to the shopper or customer in a media form such as in a catalogue, over the internet through a web site or other forms that will effectively let the shopper or customer know what graphics, images or decorative designs are available for placing on the container or dispenser.

Alternatively, the shopper or customer may provide a graphic, image or decorative design for placement on the container or dispenser. The shopper or customer may provide the graphic, image or decorative design in a media form such as a hard copy of the graphic, image or decorative design; an upload of a digital copy of the graphic, image or decorative design via a communication network; or any other media form which is suitable for transferring the graphic, image or decorative design from the current form onto the container or dispenser of the present invention.

In another alternative, the graphic, image or decorative design could be generated for the shopper. For example, a digital image could be generated by a customer for placement on a container or dispenser. Once the image is approved by the shopper, the image could be sent to the manufacturer or packager of the container or dispenser containing the product. Alternatively, the retailer could place the graphic on the blank dispenser or container and deliver the customized container to the shopper at the time of purchase. This alternative is discussed in more detail below.

Once the graphic, image or decorative design is selected and finalized by the shopper or customer, the shopper or customer is given the opportunity to place an order to purchase a specified quantity of customized containers or dispensers. This order or request to purchase the customized containers or dispensers with a useable product contained therein is processed by the manufacturer or packager. Optionally, the packager or manufacturer will review the selected or uploaded graphic, images or decorative designs to ensure that the customized design is acceptable to the standards of the manufacturer or packager. For example, a manufacturer may not want to produce a product that was or could be construed to be offensive to some. If the customized container or dispenser is acceptable to the manufacturer or packager, then the graphic, image or decorative design is then approved by the manufacturer or packager. If the graphic, image or decorative design is not acceptable, then the order for the customized container or dispenser could be, at the option of the manufacturer or packager, cancelled.

Once the graphic, image or decorative design is selected by the customer or shopper, an order is placed for the customized container and dispenser and the selected graphic, image or decorative design is optionally approved by the manufacturer or the packager, then the graphic, image or decorative design is prepared on a web of material, block 109. Once the graphic, image or decorative design is on the web of material, the graphic, image or decorative design is applied to the blank container or dispenser, block 111, and the customized container or dispenser is formed, block 113. Additional process steps may be present, such as shipping the customized container or dispenser to the customer or shopper, but these additional steps are not shown in FIG. 1. In addition, further details of each of the blocks in the flow diagram will be provided in the description below.

It is further noted that the graphic, image or decorative design selected by the shopper or customer may be modified by the packager or manufacture to indicate the source of the product, dispenser or container and remain within the scope of the present invention. For example, the manufacture of the product may want to include a trademark or brand indicator on the side wall. In that instance, the graphic, image or decorative design selected by the shopper or customer modified to provide the trademark or brand indicator. Alternatively, area for the graphic, image or decorative design may be located outside of a trademark or brand indicator which may be prepared at the same time the graphic, image or decorative design is produced for the container or dispenser.

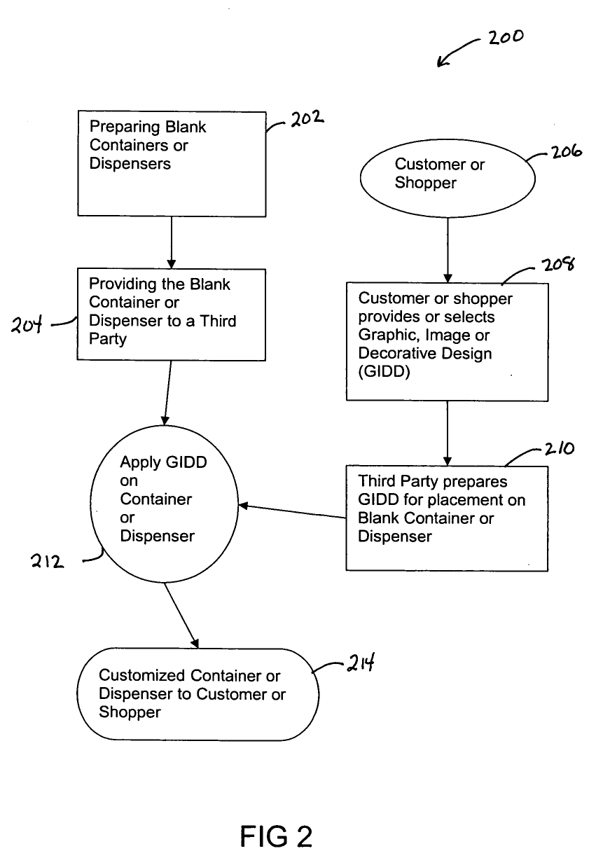

A further embodiment of the present invention is shown in FIG. 2. In this embodiment of the present invention, provided is a method 200 of preparing and providing a container or dispenser with a customized graphic, image or decorative design to a customer or shopper. In this embodiment, a manufacturer prepares a plurality of blank containers or dispensers which are filled with a product, block 202, and provides these blank containers to a third party, block 204. Before, during or after the time in which the containers or dispensers are provided to the third party, a means for a shopper or customer 206 to customize the container or dispenser with graphics, images or decorative designs desired by the shopper or customer is provided to shoppers or customers 208. In addition, before or after the customization occurs, a means may be provided for the shopper or customer to order a single or a plurality of customized containers or dispensers (not shown). Once the shopper or customer customizes and orders the customized container or dispenser, the third party prepares the customized graphics, images or decorative designs 210 and then the third party applies graphic, image or decorative design to the blank container or dispenser 212 to form a customized container or dispenser. As with the previous embodiment of the present invention, the graphic, image or decorative designs desired by the shopper or customer is applied to a web of material and the web of material is applied to an outer surface of the container or dispenser. After the third party prepares the customized container or dispenser containing the product, the third party supplies the customized container or dispenser containing the product to the shopper or customer 214. The third party may directly provide the customized container or dispenser to the customer or shopper or, in the alternative, the third party ships the customized container or dispenser to the customer or shopper.

In this embodiment of the present invention, generally, the third party can be a contractor or manufacturer that has been contracted to prepare the customized containers or dispensers. Alternatively, the third party could be a retailer that customizes the blank containers or dispensers on the retail premises. When the third party is a retailer, the third party may create the graphic, image or decorative design at the request of a customer or shopper. In one instance, the third party may use digital imagery to create the customized graphic, image or decorative design. The digital imagery may be created by a digital camera. By having a third party place the customized graphics, images or decorative designs, the manufacturer of the products can effectively produce blank containers or dispensers with the products, while relying on the expertise of a third party to apply graphics, images or decorative designs to the containers or dispensers.

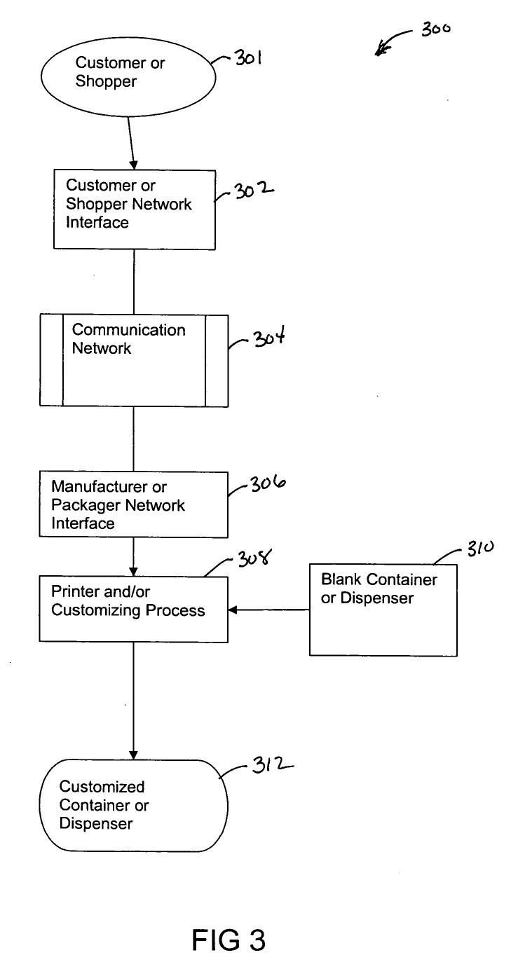

In each of the embodiments of the present invention, selection of a graphic, image or decorative design is completed through a communications system, such as a telephony network or a computer network (i.e. the Internet). An example of the communications system which will order and configure the customized container or dispenser via a communications network is shown in FIG. 3. As shown, the system 300 generally has a customer or shopper interface 302, a communications network 304 and a manufacturer, packager or other third party network interface 306. The manufacturer or packager network interface may be connected directly or indirectly with a production machine 308 which is capable of preparing the graphics, image or decorative design selected by the customer or shopper. During operation of the system, the customer or shopper 301 inputs information at the customer or shopper interface 302. The customer or shopper interface 302 may also allow the customer or shopper to select a graphic, image or decorative design provided by the manufacturer of the product. In addition to selecting a graphic, image or decorative design, the network interface may also serve to process the customer's or shopper's payment or billing and/or collect other information from the customer or shopper, such as, name, address and other similar information. Alternatively, the customer or shopper interface 302 may provide the customer or shopper with the ability to upload graphics, images or decorative designs. An example of a customer or shopper interface is a computer, such as a personal computer, including desktop and laptop (notebook) computers, wireless devices such as a hand-held personal digital assistant (PDA), cell phones and the like. The customer or shopper interface 302 may be located at the customer's or shopper's place of business, home, at a retail store, or located in a common area at a retail location (e.g. common area at a shopping center).

The communications network 304 may be a telephony network or a computer network. In the case of a telephony network, the customer interface 302 may be a telephone or a computer. Generally, if the communications network 304 is a telephony network, the manufacturer network interface may be an automated voice attendant, an interactive voice response system or a live attendant. Other forms of network interfaces may also be used in conjunction as the telephony network interface. Generally, however, it is not possible for the customer or shopper to provide the graphic, image or decorative design by an upload of the graphic, image or decorative design, unless the shopper or customer has a device that transmits images or graphics via a telephone network. An example of such a device includes, for example, cell phones with a camera built-in. If a telephony network is used, generally the graphic, image or decorative design is selected from a library of graphics, images and decorative designs.

In the case where the communications network 304 is a computer network, the manufacturer or packager network interface 306 is generally a computer server (e.g. a web server hosting a web site) which allows the customer to design or customize the graphics, images or decorative designs. Further, the computer server also allows the customers and/or shoppers to order and/or purchase the product with the customized container or dispenser. Optionally, the computer server could also allow the customer or shopper to view a virtual image of the customized container or dispenser. The virtual image could be a two dimensional view of the customized container or dispenser or could be a three-dimensional view of the customized container or dispenser.

If a communication network is used to order and customize the containers or dispensers with a graphic, image or decorative design, the blank containers or dispensers 310 are provided to the printer or customizing process 308 so that the customized containers or dispensers may be formed 312. Generally, if a communications network is used, the customized containers and dispensers are shipped to the customer or shopper once the customized containers or dispensers are formed. Alternatively, if the shopper or customer interface is located at a retail location, such as at a kiosk or other similar interface location, and the customization of the container or dispenser occurs at the retail location, it is possible that the customized container or dispenser is delivered to the customer or shopper at the retail location before the customer leaves the retail location or to have the customer or shopper return a short period of time after the customer or shopper places the order for the customized containers or dispensers to purchase the customized container or dispenser.

As described above and as shown in FIG. 1-3, the blank container or dispenser contains the product within the container. However, it is also possible for the product to be added to the container or dispenser after the container or dispenser has been customized.

Other methods may be used to customize the container or dispensers. For example, the graphic or image may be provided by the customer or shopper at a retail store location wherein the retail store forms the graphic, image or decorative design based on information provided from a shopper. A specific example of this situation is a customer or shopper takes a digital or hard copy of a picture to a retailer and the retailer uses the picture to form the customized container or dispenser. Another example, the retail store may design the graphic, image or decorative design for the shopper. Alternatively, if the design desired by the shopper is a photograph of a specific image, for example a self image of the shopper or a group of people, the retailer could use imaging technology, such as a digital camera, to take a picture of the shopper or group of people. In another embodiment of the present invention, the retailer could provide the shopper with a variety of pre-selected graphics, images or decorative designs for selection. In addition, the retailer could provide the shopper with combinations of a pre-selected graphic, image or decorative design which forms a background for an image generated by the imaging technology. For example, a digital image could be generated against a blank screen (sometimes referred to as a “green wall”) and an image is superimposed onto the selected graphic or image or set within a desired graphic which serves to frame the image, such as in the case of holiday cards. In that manner, the selected background serves as the background for the image generated against the blank screen. This procedure would be advantageous at retail locations in tourist areas, such as big cities, amusement parks, national monuments and the like, for example. Alternatively, the images could be taken on location. In this retail situation, the customized container or dispenser is provided to the shopper at the point of sale. Further, the retail location could be located where many trademarks or other source indicating indicia are used, such as an amusement park. In that situation, the customized container or dispenser could be branded with a trademark or multiply trademarks of the owner of the retail location or to a proprietor of a leased retail location where brands or trademarks are in use. This can result in co-branding of the container or dispenser of the present invention.

In addition to selecting a graphic, image or decorative design, it is also optionally possible to provide the customer or shopper with other options, for example, to select the container or dispenser shape or configuration. When submitting a request for the product, optionally, one of the required selections of the shopper or customer could be the shape or configuration of the dispenser or container. Other options could also be selected by the shopper including, for example, color of the product, scent of the product, or other product attributes that are currently available from the manufacturer of the products and containers or dispensers containing the products.

Once the graphic, image or decorative design selected by the shopper or customer is received from the shopper or customer, the graphic, image or decorative design is transferred from its current media form (including electronic) to the container or dispenser. In the present invention, the graphic, image or decorative design is applied to a web of material. The web of material may be a variety of materials including, for example, a polymeric film, a paper based layer or any other similar materials that could have a graphic, image or decorative design applied to the web of material.

The graphic, image or decorative design may be applied to the web of material using techniques known to those skilled in the art. For example, the graphic, image or decorative design may be coated onto the web of material, or imparted to the web of material using methods known to those skilled in the art, including, for example, laser printing, inkjet printing, gravure printing or flexographic printing. The printing may be completed in a single layer or by printing a series of layers. In addition, a solid color may be applied to the web of material to provide a base color for the printed graphic, image or decorative design.

Once the graphic, image or decorative design is applied on the web of material, the web of material with the graphic, image or decorative design applied thereon is positioned next to the container or dispenser. In one embodiment of the present invention, the web of material with the graphic, image or decorative design applied thereto is held next to the container or dispenser with a shrinkable polymeric film. Generally, a shrinkable film is placed over the graphic, image or decorative design on the web of material and serves to protect the graphic, image or decorative design and to hold the web of material against the container or dispenser. Alternatively, the web of material may be held adjacent the container or dispenser with an adhesive or other similar means that will hold the web of material next to the container or dispenser. In the present invention, it is desirable to use a shrinkable film to hold the web of material with the graphic, image or decorative design adjacent the container or dispenser of the present invention. When the shrinkable film is used, the container or dispenser has an overall finished look, which is pleasing to customers and shoppers.

In another embodiment of the present invention, the web of material may be a shrinkable film. In this embodiment of the present invention, the graphic, image or decorative design may be applied to a shrinkable film. When the graphic, image or decorative design is placed on the shrinkable film, it is not necessary to use an adhesive to adhere the shrinkable film to the container or dispenser. Also, when the graphic, image or decorative design is placed on a web of material which is a shrinkable film, it is not necessary to apply an additional shrinkable film to protect the graphic, image or decorative design or hold the shrinkable film in place against the container. To be clear, if the web of material which has the graphic, image or decorative design imparted thereon is not a shrinkable film, it is desirable to use a shrinkable film to hold the web of material with the graphic, image or decorative design thereon in place adjacent to the container or dispenser. However, if the web of material with the graphic, image or decorative design thereon is a shrinkable film, an additional shrinkable film is not necessary, since the shrinkable film can serve as both the web of material with the graphic, image or decorative design imparted thereto and the shrinkable film.

In the present invention, the shrinkable film should be shrinkable upon the application of heat or another type of energy to the film. Shrinkable films are known to those skilled in the art and can be prepared from a wide variety of polymer resins. Suitable resins which can be used to prepare the shrinkable film layer of the outer sheet component include, but are not limited to, for example, polyolefin resins, polyamide resins, cyclic olefin resins, polyvinyl chloride resins, thermoplastic polyester resins and polystyrene resins. Of these polymeric materials, films prepared from thermoplastic polyester resins and polyvinylchloride resins are generally desired since these resins tend to provide the best desired properties including, for example, transparency, printability, degree of firmness, gloss, and ease of processing. One specific type of shrinkable film usable in the present invention is a heat-shrinkable film.

Heat-shrinkable films can be prepared by methods known to those skilled in the art and are commercially available. For example, a heat-shrinkable film is typically prepared by heat-stretching in the machine direction a polymeric film is prepared from the polymer resins disclosed above. Heat-stretching is stretching of the polymeric film while applying heat to the film. The polymeric film is annealed and cooled in the stretched state and wound onto a roll. When heat or energy is applied to the film, the film will shrink in the direction it was stretched to return towards, but not to, it's unstretched condition. The heat shrinkage techniques, including temperature and other conditions used in the present invention may be techniques known to those skilled in the art and may be adjusted by suitably selecting the resin ingredients, film thickness, extrusion temperature, draw ratio, take-off temperature, preliminary heating conditions, stretch ratio, stretch rate, stretch temperature, annealing conditions and cooling conditions for film production. Optionally, the film may be stretched in the cross-machine direction as well.

In the present invention, the shrinkable film may be a single layer shrinkable film prepared from one or more of the polymer resins described above. Optionally, the shrinkable film may be a multilayer component, provided that one of the layers is a shrinkable film. The additional layers of the sheet component may be other polymeric films, which are also shrinkable. Since the shrinking characteristics of the films may be different, having more than one shrinkable layer may result in differential shrinking of the layers, resulting in an aesthetically undesirable container or dispenser. Therefore, care must be used if more than one shrinkable layer is used. As a result, it is generally desirable that only a single layer shrinkable film layer is used as the shrinkable film of the present invention.

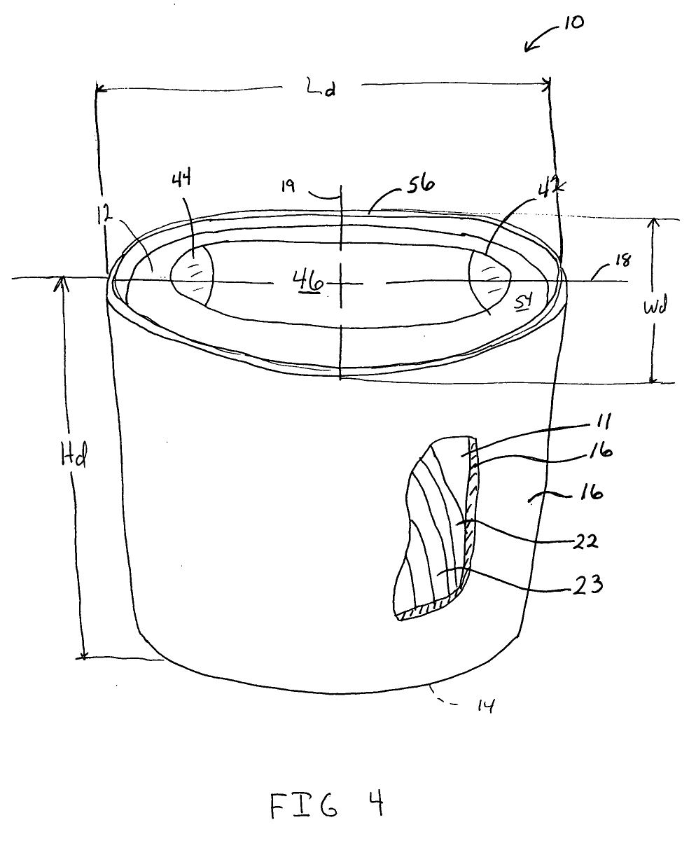

To obtain a better understanding of the present invention, attention is directed to FIG. 4. Shown in FIG. 4 is a blank container or dispenser 10 which is usable in the present invention to prepare a customized container or dispenser with a customized graphic, image or decorative design applied to the container or dispenser. It is noted that FIG. 4 shows an embodiment of the present invention, but the present invention is not intended to be limited to this embodiment. The container or dispenser 10 has a top 12, a bottom 14, and at least one sidewall 16. The sidewall 16 serves to join or connect the top 12 to the bottom 14. The sidewall 16 may be directly or indirectly joined to the top 12 and the sidewall 16 may be directly or indirectly joined to the bottom 14. By “directly joined” it is intended that the top 12 and sidewall 16 or the bottom 14 and sidewall 16 are in direct contact with one another. By “indirectly joined” it is intended that another member or structure is used to join the top 12 to the sidewall 16, or the bottom 14 to the sidewall 16. In addition, the top 12, the bottom 14 and the sidewall 16 forming the container or dispenser 10 also define an interior volume 11 of the container or dispenser 10. Located within the interior volume 11 is a product 22, which is shown as a facial tissue product in FIG. 4. The configuration of the product 22 within the container or dispenser may be placed in the interior volume 11 of the container or dispenser 10 such that the product 22 may be dispensed via pop-up dispensing.

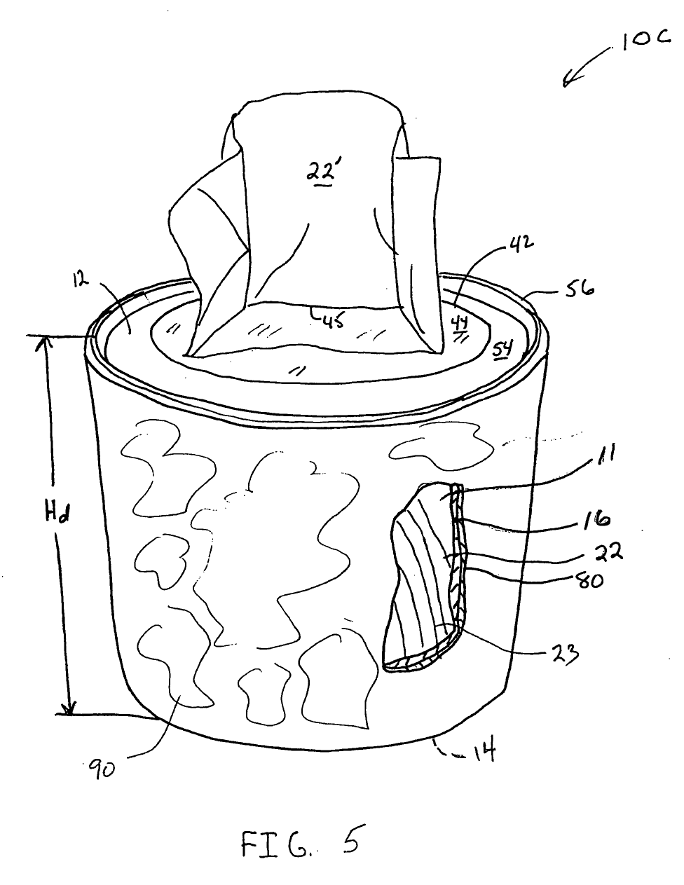

The blank container or dispenser 10 can further include an opening 42. The opening is normally located in the top 12, but the opening can be optionally located in the sidewall 16 or the bottom 14. The opening 42 allows access to the product 22 stored within the container or dispenser 10. The opening may be a reach-in opening or a pop-up dispensing opening. A reach-in opening requires the user to reach into the opening to access the product 22 therein. A dispensing opening allows the product 22 inside the container or dispenser 10 to be removed from the container or dispenser without the user reaching into the interior volume of the container or dispenser 10. A dispensing opening is shown in FIG. 5.

The container or dispenser 10 can further include an optional removable surfboard or cover 46, shown in FIG. 4. This removable cover 46 may be attached to the container or dispenser 10 by a perforated or weakened line. The removable cover 46 can be used to prevent foreign materials from entering the filled container or dispenser and provides protection for the more fragile dispensing window 44 during loading and shipping. This surfboard or cover 46 may be imparted with opening information, trademark information, source information or other information that may be important to consumers or users of the product.

The blank container or dispenser can be made from suitable materials that include, without limitation, cardboard; carton stock; paper board; thermoplastic materials such as polypropylene, polyethylene, polystyrene, ABS plastic; metal, wood, and glass, amongst other suitable alternatives. In the case of tissues, generally the container or dispenser is prepared with a carton stock, paper board or a thermoplastic material due to cost and aesthetic value which may be provided by these materials.

A dispensing opening 45 is shown in FIG. 5. Typically, dispensing openings require the user to reach into the interior volume of the container or dispenser to feed the first product from the container or dispenser 10C. Alternatively, a tab or link (not shown) to the first product in the container or dispenser may be fed through the opening so that the consumer or user can feed the first product without the need to reach into the interior volume 11 to access the first product. Once the first product 22 is fed through the dispensing opening, the next product in a stack of products 23 to be dispensed is positioned within the opening, as shown in FIG. 5. This may be accomplished by techniques known to those skilled in the art, such as interleaving the individual products using known folding techniques, such as V-folding, Z-folding and the like. For a description of these folding techniques, attention is directed to U.S. Pat. No. 3,369,700 issued to Nelson, which is hereby incorporated by reference in its entirety.

The dispensing opening 42 can optionally include a dispensing window 44, which is also shown in FIGS. 4 and 5. The dispensing window 44 can be prepared from a suitable material such as a film, nonwoven, or paper material that can retain a partially dispensed product 22′, such as a facial tissue, within the opening 42 for pop-up dispensing. The dispensing window can have a dispensing orifice 45 that can be a straight slit; a curvilinear line; a geometric shape such as an oval, a circle, or a triangle; or an X-shaped, a plus sign-shaped or an H-shaped orifice. Alternatively, the dispensing window 44 can be eliminated and fingers or tabs projecting into the dispensing opening 42 can be used to retain a partially dispensed sheet 22′. The dispensing opening 42 can be any size or shape such as square, circular, or oval. The opening 42 generally will be larger in size for a reach-in container and smaller in size for a pop-up container or dispenser.

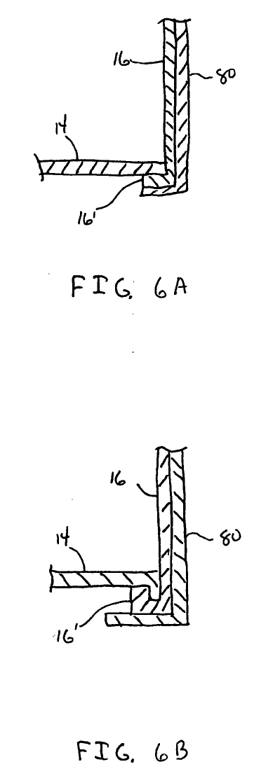

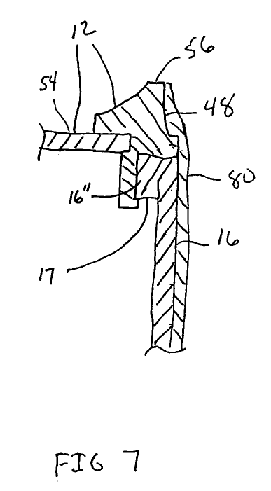

In one embodiment shown in FIGS. 4 and 5, the container or dispenser 10 and/or 10C has a generally oval shape and includes a formed oval sidewall 16 and bottom 14 which may be made from carton stock or paperboard. In this form of the container or dispenser, the bottom 14 can be either essentially even with the lower end of the sidewall 16′, as is shown in FIG. 6A or recessed from the lower end of the sidewall 16′, as is shown in FIG. 6B. The top of the container is shown in FIG. 7. In one particular embodiment, the upper end of the sidewall 16″ may be folded over on the inside of the container or dispenser to form an edge or lip 17. The container or dispenser 10 includes a snap-in top 12 having an outer ring 48 formed from a plastic material that is molded around a paperboard center portion 54 containing the dispensing opening 42, optional dispensing window 44, and optional removable cover 46. A flange on the outer ring 48 engages with the edge or lip on the interior of the sidewall 16 to secure the top 12 in place, as is shown in FIG. 7. If desired, the outer ring 48 can include a stacking lip 56 for use with a recessed bottom 14 to nest or interlock vertically stacked dispensers. Similar tops are described in U.S. patent application Ser. No. 11/021,317, filed on Dec. 22, 2004, which is hereby incorporated by reference in its entirety.

Alternative methods of constructing the container or dispenser 10 may be used. For example, a carton blank can be utilized. The carton blank can comprise a plurality of panels that are folded, assembled, and glued to form a container or dispenser. Injection molding or thermoforming can be used to form the container or dispenser. Other techniques known to those of skill in the art can be utilized to make the blank container or dispenser 10 useable in the present invention, which may be customized in accordance with the present invention.

In one embodiment of the present invention, shown in FIG. 4, the container or dispenser 10 has an overall length, Ld, measured along a longitudinal axis 18, and an overall width, Wd, measured along a transverse axis 19. The container or dispenser is oblong with the dimension for Ld greater than the dimension for Wd. In the one embodiment, the top and bottom (12, 14) comprise an oval shape and the container or dispenser has an overall length, Ld, of about 6 inches and an overall width, Wd, of about 4 inches. This results in an oval container or dispenser 10 that is visually striking and an alternately shaped container or dispenser compared to the square or rectangular boxes being currently offered for sale.

In the present invention, the blank container or dispenser 10 blank may be completely devoid of graphics or have only a portion of the container or dispenser devoid of graphics, images or decorative designs. In the portion the outer surface of the container which is devoid of graphics, images or decorative designs, the graphics, images or decorative effects are provided to the blank container or dispenser by applying a web of material 80 to the container, wherein the web of material has a graphic, image or decorative effect selected by a shopper or customer. This does not mean, however, that the blank container is devoid of any item which may enhance the graphic, image or visual effect selected by the customer or shopper. For example, graphics, images or visual effects selected by the shopper or customer may be further enhanced by providing the exterior surface of the sidewall 16 with a base color which will be visible through the imprinted graphic, image or decorative design present on the web of material, in particular when the web of material is shrinkable film. In addition, the visual effect can further be enhanced by providing the exterior surface of the sidewall 16 with a material which will produce a three-dimensional effect. Examples of such materials include metallized films which can be placed between the exterior of the sidewall and the web of material. More specifically, between the sidewall and the shrinkable film. The metallized films are capable of producing holographic and three dimensional effects. In addition, Fresnel lenses may also be used to enhance the three-dimensional effect of the graphics or decorative design imprinted on the shrinkable film. In an alternative embodiment of the present invention, the metallized film may be imparted with the graphic, image or decorative design and serve as the web of material of the present invention. When this is the case, a shrinkable film may be used to hold the metallized film with the graphic, image or decorative design in place. Such metallized films are known in the art. One company having the ability to produce films containing holographic and/or Fresnel lenses is Coburn Graphic Films, Inc., having an office at 1650 Corporate Road West, Lakewood, N.J. 08701. A tissue carton utilizing these films entitled Decorative Film, Carton, And Method Of Making, U.S. Ser. No. 10/374,185 filed with the United States Patent Office on Feb. 25, 2003, published as U.S. 2004/0166258 A1 on Aug. 25, 2004. This patent application Publication is herein incorporated by reference in a manner consistent herewith.

In one embodiment of the present invention, as is shown in FIG. 5, the web of material 80 serves to provide graphics, images or decorative visual effects 90 to the at least one sidewall 16. This web of material 80 covers a majority of the exterior surface of the at least one sidewall 16. By a majority of the exterior surface, it is intended that at least 50% of the exterior surface area of the exterior surface of the at least one sidewall 16 is covered by the outer sheet component. Ideally, the web of material 80 covers at least 75% of the exterior surface area of the sidewall 16 and desirably at least 95% of the exterior surface area of the sidewall 16. In one particular embodiment of the present invention, the web of material 80 covers 100% of the exterior surface of the sidewall 16. The web of material 80 may also extend beyond the sidewall 16 to partially or fully cover the top 12 and/or bottom 14. Generally, the web of material should not cover the dispensing opening unless a means for accessing the dispensing opening through the web of material is provided. In addition, it this embodiment, the graphic, image or decorative design may be printed in a reverse image, so that the graphic, image or decorative design appears in the correct perspective when the viewed through the web of material,

In the present invention, the web of material 80 may have a single layer or may be multilayered. Generally, the web of material is a single layer. As is stated above, the web of material may be a shrinkable film, for example, a heat shrinkable film. Alternatively, the web of material is not a shrinkable film but is another material which has the graphic, image or decorative design applied thereto. When the web of material is not a shrinkable film, a shrinkable film is applied over the web of material to hold the web of material in place adjacent the sidewall of the blank container or dispenser. The shrinkable film also serves to give the customized container or dispenser an overall finished look. When the web of material with the graphic, image or decorative design imparted thereto is a shrinkable film, an additional shrinkable film to hold the web of material in place adjacent the container or dispenser is unnecessary, since the shrinkable film will conform to the container or dispenser such that an additional shrinkable film is unnecessary. However, this does not mean that another shrinkable film cannot be placed over the shrinkable film with the graphic, image or decorative design imparted thereto.

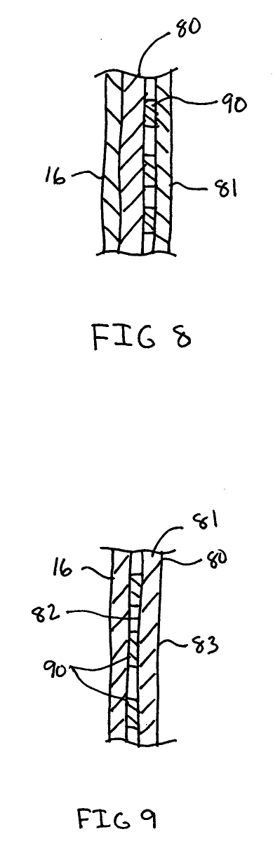

The graphics, images or decorative designs 90 selected by the shopper or customer to be placed on the container or dispenser 10 or 10C of the present invention may be imparted in a number of ways. In one embodiment of the present invention, the graphic, image or decorative design selected or uploaded by a shopper or customer is applied on a web of material 80 which is placed on the outer surface of the sidewall 16 of the container or dispenser 10 or 10C. The graphic, image or decorative design may be coated or imparted to the web of material using methods known to those skilled in the art, including, for example, inkjet printing, gravure printing or flexographic printing. The printing may be completed in a single layer or by printing a series of layers. In addition, a solid color may be applied to the web of material to provide a base color for the printed graphic, image or decorative design. As is set forth above, this web of material may be adhesively mounted to the exterior surface of the sidewall 16 or just wrapped around the exterior surface of the sidewall and held into place by the shrinkable film 81, as shown in FIG. 8. In this case, the shrinkable film 81 may be free of graphics, images or decorative designs, or may contain an additional or complementary decorative design. As an example of this embodiment of the present invention, the web of material 80 may be a paper-based web of material and the graphic, image or decorative design is imparted thereto. A heat-shrinkable film or otherwise shrinkable film 81 is applied over the web of material 80 to protect the graphic, image or decorative design 90 on the web of material and/or to hold the web of material 80 with the graphic, image or decorative design in place against the container or dispenser. In an alternative embodiment, (not shown) if the web of material 80 is clear, the graphic, image or decorative design could be on the side of the web of material which is in contact with the sidewall 16. The overall result is a container or dispenser with a customized graphic, image or decorative design applied thereto.

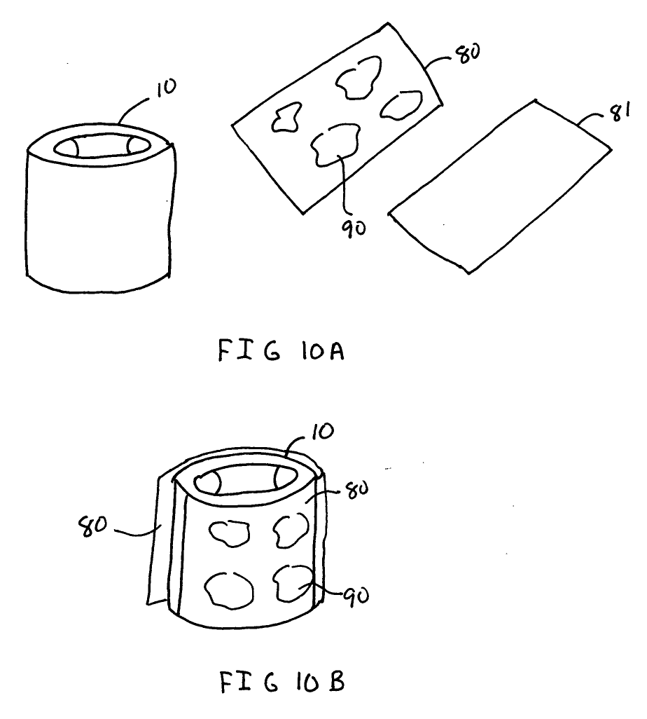

In an alternative embodiment of the present invention, the web of material may be a shrinkable film and has a graphic, image or decorative design selected or uploaded by a shopper or customer imprinted on one of the surfaces of the shrinkable film. In this regard, attention is directed to FIG. 9. The shrinkable film 81 has an interior surface 82 and an exterior surface 83, wherein the exterior surface forms the outer surface of the article of the present invention and the interior surface of the shrinkable film faces the exterior surface of the sidewall 16 of the container or dispenser 10. Generally, the shrinkable films are transparent or translucent and do not have any color other than being clear. Alternatively, the shrinkable film may be colored. The graphic or decorative design may be coated or imparted to the shrinkable film using methods known to those skilled in the art, including, for example, inkjet printing, gravure printing or flexographic printing. The printing may be completed in a single layer or by printing a series of layers. In addition, a solid color may be applied to the film to provide a base color for the printed graphic or decorative design. The graphic or decorative design 90 may be imparted on the exterior surface 83 of the shrinkable film or may be imparted on the interior surface 82 of the shrinkable film. From a standpoint of durability, it is desirable that the interior 82 surface of the shrinkable film 81 be imparted with the graphic or decorative design, as is shown in FIG. 9. When the graphic or decorative design 90 is on the interior surface 82 of the shrinkable film 81, the shrinkable film 81 will serve to protect the graphic or decorative design 90 from damage due to use of the container or dispenser, from being in contact with other objects or moving the container or dispenser from one location to another location.

Any type of ink may be used to imprint the shrinkable film, provided that the ink is not susceptible to degradation when heat or other forms of energy is applied to the ink. Both metallic and non-metallic inks may be used in the present invention to imprint the film with a graphic or decorative design. In addition to conventional inks, inks with special properties, such as, glow in the dark properties, may also be used. Generally, the entire surface of the shrinkable film will be printed; however, it is possible to print only a portion of the film. For example, 20% or less of the film surface may be printed, in the case where the graphic is a monogram or the like. Typically, at least 50% or more typically at least 80% or 90% of the shrinkable film surface will be printed. Alternatively, a smaller portion of the film may be printed, if desired. For example, a substantially smaller portion of the shrinkable film may be printed if desired, such as if the desired printing is a monogram or the like.

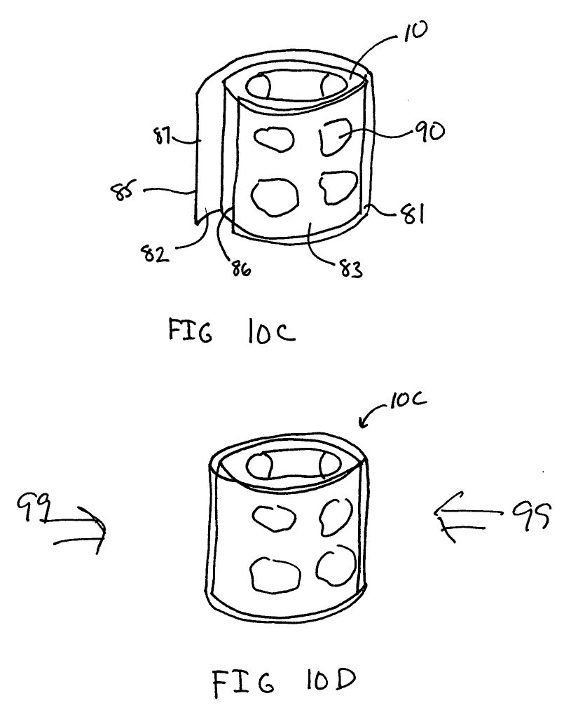

Shown in FIGS. 10A-D is a method which may be used to prepare the customized container or dispenser 10C where the graphics 90 are on a web of material 80 and the web of material is covered by a shrinkable film 81. First, a blank container or dispenser 10 is provided along with a web of material 80 having a graphic, image or decorative design 90 imparted thereon and a shrinkable film 81, as shown in FIG. 10A. As described above, the graphic, image or decorative design may be applied using methods know to those skilled in the art. The web of material 80 with the graphic, image or decorative design 90 applied thereto is wrapped around the container or dispenser, as is shown in FIG. 10B. This web of material 80 may be held in place with an adhesive or the web of material may be merely wrapped around the container or dispenser. Not shown in FIG. 10A or 10B, the web of material may alternatively be in the form of a continuous sheet commonly referred to as a sleeve. In that case, the sleeve is slid onto the container or dispenser. In either case, as shown in FIG. 10C, the shrinkable film 81 is wrapped around the container or dispenser 10 with the web of material 80 with the graphic, image or decorative design 90 formed in FIG. 10B. As with the web of material 80, the shrinkable film 81 may be a continuous sheet in the form of a sleeve (not shown). Generally, to apply the shrinkable film 81 to the container or dispenser 10 of the present invention, the shrinkable film 81 is wrapped around the container or dispenser, such that the first end 85 of the film contacts and overlaps the second end 86 of the film, as is shown in FIG. 10C. This results in a shrinkable film with a continuous exterior surface 83. In the area of overlap 87, a means for holding the two ends of the film together is used. The exterior surface 83 of the second end 86 which will be overlapped with the first end 85 may be imparted with an adhesive, a double-stick tape or other means that will effectively hold the interior surface 82 first end 85 and the second end 86 of the shrinkable film 81 together. Alternatively, the interior surface 82 of the first end 85 which will overlap the second end 86 may be imparted with means to hold the two ends together. Generally, if an adhesive is used, the adhesive should be selected from those adhesives that are not adversely affected by the application of heat to the adhesive. Solvent based adhesive may serve well in this application such that the adhesive welds the two ends 85, 86 of the shrinkable films together. Alternatively, the shrinkable film may be formed into a tube-like structure, having a continuous exterior surface, prior to placing the shrinkable film around the container or dispenser 10. In either case, the shrinkable film once brought together should be slightly larger than the circumference of the outer surface of the at least one sidewall 16 of the container or dispenser. Generally, the shrinkable film should be 2-10% larger than the circumference of the exterior surface of the at least one sidewall 16. If the circumference is any larger than about 10% of the circumference or perimeter of the container or dispenser 10, then the shrinkable film may not shrink evenly, causing the container to have an unappealing surface.

Once the shrinkable film 81 is placed around the exterior surface of the sidewall, energy 99 is applied to the film, such as heat or another energy source, as is shown in FIG. 10D. If heat is used as the energy source, the shrinkable film is called a heat-shrinkable film and is heated with a suitable heating means, for example, hot air, to shrink the film around the container or dispenser. If the film can be shrunk by other means, the other means, such as microwave energy may be used. The temperature to which the heat-shrinkable film is heated is dependent on several factors, including the type of polymer used to prepare the heat-shrinkable film or the inks used to prepare the graphic, image or decorative design on the heat-shrinkable film or otherwise present on the container or dispenser.

It is noted that the process is essentially the same as described above when the web of material 80 is a shrinkable film 81, except that the process of FIG. 10B is omitted. That is, the web of material 80 shown in FIG. 10B is not applied as shown and this step in the process is skipped. Again, this is for the situation where the decorative design is provided on the shrinkable film.

In addition to covering the exterior surface of the sidewall 16 of the container or dispenser 10 of the present invention, the shrinkable film may extend beyond the sidewall 16 and partially or entirely cover the bottom 14 or top 12. In an embodiment shown in FIGS. 6A, 6B and 7, the web or material 80 is shown as a shrinkable film 81 and may extend to the top 12 and the bottom 14 of the container or dispenser of the present invention. By having the shrinkable film extend to the top 12 and bottom 14, the container or dispenser has an overall finished appearance as compared to containers where the shrinkable film only covers a portion of the exterior surface. In the case where the bottom is recessed, as is shown in FIG. 6B, the shrinkable film may extend beyond the lower edge 16′ of the sidewall 16. This will result in the bottom edge of the film not contacting the bottom of the container or dispenser, as shown in FIG. 6B.

In the present invention, the graphics, images or decorative designs selected by the shopper or customer include a wide variety of items. For example, objects that are considered decorative in design include flowers, landscapes, cityscapes, pictures of buildings, pictures of people, abstract designs, patterned designs, or other similar graphics or designs. The particular designs provided on the articles of manufacture of the present invention are not critical to the present invention. Generally, however, it is desirable that the graphics or decorative designs are not offensive to large groups of people.

In the present invention, the outer sheet component could be made in-line with the packaging of the products into the container or dispenser or the outer sheet component could be prepared off-line.

The container or dispenser 10 can also include an optional removable film overwrap (not shown) to further cover the dispensing opening 42 or outer portion of the dispenser. The film overwrap can be used to display printed information, such as a prominent trademark, size of the sheets, the number of sheets, information on how to open the container or dispenser, or patent information, which can later be removed by the consumer so as to not detract from the graphic design of the container or dispenser imparted by the outer sheet component discussed below. This overwrap is in addition to the web of material 80 and/or the shrinkable film 81.

By providing the container or dispenser of the present invention with a graphic, image or design selected or provided by a customer or shopper, customers and shoppers are allowed to design containers or dispensers which easily fit into the décor of the home, car or office. As a result, the manufacturer of the containers or dispensers with the product therein, can provide products to a customer or shopper in a package which is personalized by the customer or shopper. In addition, the manufacturer or packager can obtain information from the shoppers and customers as to which graphic, images or designs are preferred by shoppers and customers, thereby enabling the manufacturer or packager to provide the more popular designs in retail channels, rather than or in addition to a catalog or internet based ordering system.

Other advantages includes providing a way for a retailer to order container or dispenser designs it believes would be popular or testing designs in a few select stores prior to placing a large order for a given design. As such, the retailer and manufacturer can easily identify designs which might not be well received by consumers, while identifying others which might be popular. In addition, the present invention provides an easy and economical way to produce short runs of a given design or short runs of season graphics without the need of ordering large quantities of containers or dispensers.

One major advantage provided by the present invention is that a customer or shopper could order a plurality of containers or dispensers each with different graphics, images or decorative designs selected or provided by the customer or shopper. In addition, a manufacturer or packager could use the present invention to provide a plurality of different graphics or decorative designs on essentially identical dispensers or containers. As such, a plurality of “blank” dispensers or containers could be imparted with a variety of graphics or decorative designs. Each of the blanks could be the same or may be different. Generally, all of the blanks will be essentially the same with some minor variations therein. As such, a case containing a plurality of the dispensers or containers of the present invention could be provided, from the plurality of blanks, but the dispensers or containers would have a plurality of different graphics, images or decorative designs within a given case. Stated another way, the graphics, images or decorative designs on the web of material is different from the graphics, images or decorative designs on at least one other web of material present in the case of articles. Ideally, there could be two, three, four or more different images, graphics or decorative designs in a given case. In one aspect, each dispenser or container in the case could have a different image, graphic or decorative design, but each blank carton could be the same. This would provide a manufacturer or packager of these dispensers or containers with a way to efficiently provide retailers a variety of designs in a given case of dispenser or containers. As a result, consumers would be provided with a variety of designs to select from at the retail store.

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A method for customizing graphics, images or decorative designs on a container, said method comprising
a) providing a blank container;
b) providing a shopper or customer with the ability to select or provide a graphic, image or decorative design to be placed on the blank container;
c) having the shopper or customer select or provide a graphic, image or decorative design to be placed on the blank container;
d) preparing the graphic, image or decorative design selected by the shopper or customer on a web of material; and
e) positioning the web of material having the graphic, image or decorative design selected by the shopper or customer next to the blank container, and holding the web of material with the graphic, image or decorative design selected by the shopper or customer adjacent to the container with a shrinkable polymeric film, thereby forming a customized container.

2. The method according to claim 1, wherein the blank container contains a usable product.

3. The method according to claim 2, wherein the usable product comprises a personal care product.

4. The method according to claim 3, wherein the personal care product comprises facial tissue.

5. The method according to claim 1, wherein the graphic, image or decorative design is provided to the customer or shopper for selection as a set of graphics and/or images.

6. The method according to claim 1, wherein the graphic, image or decorative design is provided by the customer or shopper.

7. The method according to claim 1, wherein the shrinkable film is a heat-shrinkable polymeric film and the method further comprises applying heat to the heat-shrinkable polymeric film to cause the heat-shrinkable polymeric film to shrink and to conform to the container.

8. The method according to claim 1, wherein the blank container comprises a top surface, a bottom surface opposite the top surface and at least one side surface joining the top surface to the bottom surface, and the graphic, image or decorative design selected by the shopper or customer is placed on the at least one side surface.

9. The method according to claim 8, wherein the at least one side surface comprises a single sidewall, the single sidewall having a curvilinear shape, wherein the container is substantially free of any corners along the perimeter of the single sidewall.

10. The method according to claim 9, wherein the graphic, image or decorative design is printed on a web of material, the web of material is applied to the sidewall of the container and the shrinkable polymeric film is applied over the web of material to hold the web of material in place against the container.

11. The method according to claim 10, wherein the shrinkable film is a heat-shrinkable polymeric film and the method further comprises applying heat to the heat-shrinkable polymeric film to cause the heat-shrinkable polymeric film to shrink and to conform to the container.

12. The method according to claim 1, wherein the method steps b) providing a customer or shopper with the ability to select a graphic, image or decorative design to be placed on the blank container and c) having the shopper or customer select a graphic, image or decorative design to be placed on the blank container, are provided via a communications network.

13. The method according to claim 1, further comprising providing the customized container to the customer or shopper.

14. The method according to claim 13, wherein the method steps b) providing a customer or shopper with the ability to select a graphic, image or decorative design to be placed on the blank container and c) having the shopper or customer select a graphic, image or decorative design to be placed on the blank container, are provided via a communications network.

15. The method according to claim 6, wherein the customer provides the graphic, image or decorative design via a communications network.

16. The method according to claim 14, wherein the communications network comprises a computer interface.

17. The method according to claim 16, wherein the computer interface is located at a retail location.

18. The method according to claim 16, wherein the communications network comprises the internet.

19. The method according to claim 1, wherein the blank container contains facial tissue, the customer provides the graphic, image or decorative design via a communications network, the web of material is printed with the graphic image and is applied to the sidewall of the container, the shrinkable polymeric film is applied over the web of material wherein the shrinkable polymeric film is a heat-shrinkable polymeric film, then heat is applied to the heat-shrinkable film to cause the film to shrink and to conform to the container resulting in the heat-shrinkable film holding the web of material in place against the sidewall of the container.

20. A method for providing customizing graphics, images or decorative designs on a container, said method comprising
a) providing a blank container comprising a top surface, a bottom surface opposite the top surface and at least one side surface joining the top surface to the bottom surface, the at least one side surface having a total surface area equal to the area of all of the side surfaces present on the blank container;
b) providing a customer or shopper with the ability to select a graphic, image or decorative design desired by the shopper or customer to be placed on the blank container;
c) having the shopper or customer select at least one graphic, at least one image or at least one decorative design desired by the shopper or customer to be placed on the blank container;
d) preparing the selected graphic, image or decorative design selected by the shopper or consumer on a web of material; and
e) applying the web of material with the graphic, image or decorative design onto the at least one side surface of the blank container such that at least 50% of the total surface area is covered by the graphic, image or decorative design.

21. The method according to claim 20, wherein the blank container or dispenser contains a usable product.

22. The method according to claim 21, wherein the usable product comprises a personal care product.

23. The method according to claim 22, wherein the personal care product comprises facial tissue.

24. The method according to claim 20, wherein the graphic, image or decorative design is provided to the customer or shopper for selection as a set of graphics and/or images.

25. The method according to claim 20, wherein the graphic, image or decorative design is provided by the customer or shopper.

26. The method according to claim 20, wherein the graphic, image or decorative design is printed on the shrinkable polymeric film, wherein the shrinkable film is a heat-shrinkable polymeric film, the heat-shrinkable polymeric film is wrapped around the container to cover the at least one side surface and heat is applied to the heat-shrinkable polymeric film to cause the heat-shrinkable polymeric film to shrink and to conform to the side surface of the container.

27. The method according to claim 20, wherein the graphic, image or decorative design is printed on a web of material, the web of material is applied to the side surface of the container and a shrinkable polymeric film is applied over the web of the material to hold the web of material in place against the side surface.

28. The method according to claim 27, wherein the shrinkable film is a heat-shrinkable polymeric film and the method further comprises applying heat to the heat-shrinkable polymeric film to cause the heat shrinkable polymeric film to shrink and to conform to the container.

29. The method according to claim 20, wherein the at least one side surface comprises a single sidewall, the single sidewall having a curvilinear shape, wherein the container is substantially free of any corners along the circumference of the single sidewall.

30. The method according to claim 20, wherein the method steps b) providing a customer or shopper with the ability to select a graphic, image or decorative design to be placed on the blank container and c) having the shopper or customer select a graphic, image or decorative design to be placed on the blank container, are completed via a communications network.

31. The method according to claim 30, wherein the communications network comprises a computer interface.

32. The method according to claim 31, wherein the computer interface is located at a retail location.

33. The method according to claim 31, wherein the communications network comprises the internet.

34. The method according to claim 20, further comprising providing the customized container to the customer or shopper.

35. A method for customizing graphics images or decorative designs on a container, said method comprising
a) providing a blank container containing a personal care product;
b) providing an interface via a communications network for a shopper or customer to select graphics, images or decorative designs from a server connected to the communications network or upload graphics, images or decorative designs to a server connected to the communications network;
c) having the shopper or customer select or provide at least one graphic or at least one image on the server or uploaded to the server desired by the shopper or customer to be placed on the blank container;
d) printing the selected graphic, image or decorative design desired by the shopper or consumer onto a web of material;
e) applying the web of material with the graphic, image or decorative design onto the blank container to form a customized container; and
f) providing the customized container to the shopper or customer.

36. The method according to claim 35, wherein the personal care product comprises a facial tissue.

37. The method according to claim 35, wherein the graphic, image or decorative design is provided to the customer or shopper for selection as a set of graphics and/or images on the server.

38. The method according to claim 35, wherein the graphic, image or decorative design is provided by the customer or shopper.

39. The method according to claim 35, wherein the communication network comprises the internet.

40. The method according to claim 35, wherein the web of material comprises a heat-shrinkable polymeric film, the heat-shrinkable film is wrapped around the container to cover a side surface of the container and heat is applied to the heat-shrinkable polymeric film to cause the heat-shrinkable polymeric film to shrink and to conform to the side surface of the container.

41. The method according to claim 35, wherein the web of material is applied to a side surface of the container and a heat-shrinkable polymeric film is applied over the web of the material to hold the web of material in place against the side surface.

42. The method according to claim 41, further comprising applying heat to the heat-shrinkable polymeric film to cause the heat-shrinkable polymeric film to shrink and to conform to the container.

43. A method of providing customized graphics, images or decorative designs on a container for a product, said method comprising
a) preparing a plurality of blank containers containing a product;
b) providing the plurality of blank containers to a third party;
c) providing a means for a shopper or customer to customize the container with graphics, images or decorative designs desired by the shopper or customer;
d) providing a means for the shopper or customer to order the customized container with graphics, images or decorative designs desired by the shopper or customer;
e) once the shopper or customer orders the customized container, having a third party prepare and apply the customized graphics, images or decorative designs to the blank container to form a customized container; and
f) having the third party supply the customized container containing the product to the shopper or customer.

44. The method according to claim 43, wherein the means for the shopper or customer to customize the container and the means for the shopper or customer to order the customized container each comprises a communications network.

45. The method according to claim 44, wherein the communications network comprises the internet.

46. The method according to claim 43, further comprising approving the shopper or customer selected graphics, images or decorative deigns prior to applying the desired graphics, images or decorative designs onto the container.

47. The method according to claim 43, wherein the third party prints the selected graphic, image or decorative design desired by the shopper or consumer onto a web of material and then the third party applies the web of material with the graphic, image or decorative design onto the blank container to form a customized container.

48. The method according to claim 47, wherein the web of material comprises a heat-shrinkable polymeric film, the heat-shrinkable film is wrapped around the container to cover a side surface of the container and heat is applied to the heat-shrinkable polymeric film to cause the heat-shrinkable polymeric film to shrink and to conform to the side surface of the container.

49. The method according to claim 47, wherein the web of material is applied to a side surface of the container and a heat-shrinkable polymeric film is applied over the web of the material to hold the web of material in place against the side surface.

50. The method according to claim 49, further comprising applying heat to the heat-shrinkable polymeric film to cause the heat-shrinkable polymeric film to shrink and to conform to the container.

51. The method according to claim 43, wherein the graphic, image or decorative design is provided by the customer or shopper via a communications network.

52. The method according to claim 43, wherein the means for a shopper or customer to customize the container comprises having the third party use digital imagery at the request of the customer or shopper to form the graphic, image or decorative design.

53. The method according to claim 52, wherein the digital imagery is created by a digital camera.
